(19) United States
(12) Patent Application Publication
(10) Pub. No.: US 2006/0143405 A1
(43) Pub. Date: Jun. 29, 2006

(54) Data processing device

(75) Inventors: Makoto Ishikawa, Novi, MI (US); Tatsuya Kamei, Kokubunji (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/315,320

(22) Filed: Dec. 23, 2005

(30) Foreign Application Priority Data
Dec. 28, 2004 (JP) 2004-379598

(51) Int. Cl. G06F 13/28

(52) U.S. Cl. 711/141; 711/206

(57) ABSTRACT

A data processor has a central processing unit and a plurality of logical blocks (1104) to be connected to the central processing unit, and the central processing unit sets a predetermined logical block to be a control object based on a result of decode of a predetermined instruction code (CBP) and a function of the predetermined logical block is selected based on the result of decode of the predetermined instruction code and a part of address information which is incidental to the predetermined instruction code (TAG [14:13]). It is possible to decide an operating object in an early stage before reaching a memory access stage of a pipeline without requiring to allocate the instruction code in a one-to-one correspondence for the operation of the predetermined logical block. Consequently, it is possible to suppress a consumption of the instruction code, a useless power consumption and a reduction in a processing performance of an operation for a specific logical block, for example, a cache coherency operation or a TLB page attribute operation in the same operation.

### CLAIM OF PRIORITY

The present application claims priority from Japanese application JP 2004-379598 filed on Dec. 28, 2004, the content of which is hereby incorporated by reference into this application.

### FIELD OF THE INVENTION

The present invention relates to a data processor represented by a microprocessor, and more particularly to a system for controlling and managing, by software, an associative memory for carrying out an associative operation, for example, a cache memory or a TLB (Translation Look-aside Buffer).

### BACKGROUND OF THE INVENTION

Conventionally, a processor system mounts a cache memory for being operated by copying a part of an instruction or data on to a high speed memory having a small capacity which is disposed in a main memory as means for enhancing a memory access performance. Since the cache memory has a smaller capacity than the capacity of the main memory, it is impossible to dispose all data in the main memory. However, a transfer to the main memory is automatically carried out on a hardware basis if necessary. Therefore, an ordinary program can be operated without a consciousness of the presence of the cache memory.

The cache memory carries out a data transfer together with the main memory on a greater unit than a data unit handled by a data processor which is referred to as a line. In a typical cache method, states of a line which are referred to as “invalidate”, “clean” and “dirty” are given. The “invalidate” indicates a state in which the data of the main memory are not allocated to a cache line, the “clean” indicates a state in which data are allocated to the cache line and are coincident with the data of the main memory, and the “dirty” indicates a state in which the data allocated to the cache line are rewritten by a processor but old data are left in the main memory.

Although it is not necessary to become conscious of the presence of the cache memory in relation to the ordinary program as described above, in the case of direct access to the main memory from an external device without using the cache memory, it is necessary to carry out an operation for invalidating the contents of the cache memory by software and forcibly writing contents written to the cache memory back into the main memory.

This is referred to as a cache coherency control. In order to carry out the cache coherency control, means for operating the cache memory is generally offered to the processor.

For more specific contents of the operation of the cache coherency control, it is possible to define a plurality of methods referred to as “purge”, “invalidate” and “write-back”. The “purge” can be defined as a method of carrying out a transition to an invalid state over a line set in a dirty and clean state and writing data on a line back into the main memory if an original state is dirty, the “invalidate” can be defined as a method of carrying out the transition to the invalid state in the same manner as in the “purge” and performing no write-back even if the original state is dirty, and the “write-back” can be defined as a method of carrying out a transition from “dirty” to “clean” and performing the write-back.

In the cache coherent operation a specific line is designated by software, and a plurality of line designating methods is provided. One of them is a method of directly designating a line and another method is a method of making a hit decision (associative operation) of the cache memory and designating the line as an operating object when the decision of hit is obtained. The former method will be referred to as “non-associative” and the latter method will be referred to as “associative”. In other words, it is possible to propose six combinations of associative/non-associative X purge/invalidate/write-back as the coherency operation described above. Referring to non-associative and associative, a processing efficiency is taken into consideration depending on a size (the number of lines) of a region to be operated. The software carries out a proper use, for example, the “non-associative” is set if the region is large and the “associative” is set if the region is small.

A coherency control designating method to be carried out by software is varied depending on a processor, and includes a method of carrying out a designation through an instruction and a method of writing specific data to a special address. For the former method, a one-to-one instruction code is allocated every operation type. For the latter method, a data transfer instruction is utilized to designate the contents of an operation in a combination of an address and data. This method has been described in Patent Document 1.

While the description has been given to the coherency operation intended for the cache memory, moreover, a page attribute operation for a TLB using an associative memory also has a similar operation to the cache coherency control operation. The page attribute operation indicates an operation for changing an address translation map by the TLB.

[Patent Document 1] JP-A-8-320829 Publication

### SUMMARY OF THE INVENTION

As described above, the operations of the cache memory and the TLB have a plurality of variations. First of all, a method of designating an operation by software will be investigated. In a method of giving a one-to-one instruction code for each operation type, instruction codes are consumed corresponding to the number of the variations. It is hard to apply the same method to the case in which an instruction code space is limited in an architecture of an 8-bit or 16-bit fixed-length instruction code. On the other hand, although a method of designating the contents of an operation in a combination of an address and data by utilizing a data transfer instruction does not consume a new instruction code, it cannot specify whether the contents of the processing are a normal data transfer or a cache operation in an instruction decoding stage to be carried out in an early stage of a processor pipeline. It is impossible to specify whether the contents of the processing are the cache operation or not until the execution of an instruction proceeds to a memory access stage of the pipeline. The normal data transfer is a high-priority processing which greatly influences the performance of the processor. For this reason, the data transfer is operated preferentially without deciding whether the contents are the cache operation or not. As a result, the cache memory carries out a useless associative operation so that a consumed power is increased. Moreover, there is a problem in that the processing performance of the cache operation is deteriorated in a method of discriminating data which are determined in a late stage of a pipeline to determine the contents of the cache operation.

It is an object of the invention to suppress the consumption of an instruction code, a useless power consumption and a deterioration in the processing performance of the operation in an operation for a specific logical block such as a cache coherency operation or a TLB page attribute operation.

The above and other objects and novel features of the invention will be apparent from the description of the specification and the accompanying drawings.

Brief description will be given to the summary of the typical invention disclosed in the application.

[1] A data processor has a central processing unit and a plurality of logical blocks to be connected to the central processing unit, and the central processing unit sets a predetermined logical block to be a control object based on a result of decode of a predetermined instruction code, and a function of the predetermined logical block is selected based on the result of decode of the predetermined instruction code and a part of address information which is incidental to the predetermined instruction code.

As described above, it is not necessary to allocate an instruction code in a one-to-one correspondence to the operation of the predetermined logical block and it is possible to hold the number of the allocated instruction codes to be small. In particular, the result of decode of the instruction code and the address information which is incidental to the predetermined instruction code are used for selecting the function of the logical block. Consequently, at least two instruction codes are allocated to the operation of the predetermined logical block. Furthermore, it is possible to decide an operating object in an early stage before reaching the memory access stage of a pipeline and to suppress the operating power of a useless logical block, and to prevent the number of cycles required for the operation from being increased.

As a typical configuration of the invention, the predetermined logical block is a cache memory and the function to be selected is an associative mode using an associative retrieval for a cache coherency control or a non-associative mode which does not use the associative retrieval. The function to be selected is contents of the cache coherency control. The contents of the cache coherency control are purge, write-back and invalidate, for example.

As another typical configuration of the invention, the predetermined logical block is a TLB and the function to be selected is an associative mode using an associative retrieval in a page attribute operation control of the TLB or a non-associative mode which does not use the associative retrieval. The function to be selected is contents of the page attribute operation control. The contents of the page attribute operation control are making dirty, making clean and invalidate, for example.

[2] A data processor has a central processing unit and a plurality of logical blocks to be connected to the central processing unit, and the central processing unit sets a predetermined logical block as a control object based on a result of decode of a predetermined instruction code, and a function of the predetermined logical block is selected based on a part of address information which is incidental to the predetermined instruction code. In particular, the incidental address information to the predetermined instruction code is used for selecting the function of the logical block. Therefore, it is preferable to allocate at least one instruction code to the operation of the predetermined logical block. In this respect, it is possible to minimize the instruction code to be allocated to the operation of the predetermined logical block. In the same manner as described above, furthermore, it is possible to decide the operating object in an early stage before reaching the memory access stage of the pipeline, to suppress the operating power of a useless logical block and to prevent the number of cycles required for the operation from being increased.

As a typical configuration of the invention, the predetermined logical block is a cache memory and the function to be selected is an associative mode using an associative retrieval for a cache coherency control or a non-associative mode which does not use the associative retrieval, and contents of the cache coherency control. The contents of the cache coherency control are purge, write-back and invalidate, for example.

As another typical configuration of the invention, the predetermined logical block is a TLB and the function to be selected is an associative mode using an associative retrieval in a page attribute operation control of the TLB or a non-associative mode which does not use the associative retrieval, and contents of the page attribute operation control. The contents of the page attribute operation control are making dirty, making clean and invalidate, for example.

[3] A data processor according to yet another aspect of the invention has a logical block to be activated by using a predetermined instruction code, and a function of the logical block which is activated is selected by using the instruction code and a part of addresses which are incidental to the instruction code.

A data processor according to a further aspect of the invention has a logical block to be activated by using a predetermined instruction code, and a function of the logical block which is activated is selected by using apart of addresses which are incidental to the instruction code.

### BRIEF DESCRIPTION OF THE DRAWINGS

FIG. 1 is a block diagram illustrating an internal structure of a cache memory to be an operating object by a cash operating instruction in FIG. 2,

FIG. 2 is an explanatory diagram showing an example of the cache operating instruction for implementing a cache operation,

FIG. 3 is a timing chart showing an example of a memory access pipeline after instruction decoding according to the invention in a pipeline of a general data processor,

FIG. 4 is an address map showing a virtual memory map of the data processor,

FIG. 5 is a block diagram showing an inner part of a cache memory according to a comparative example proposed by the inventor in order to implement the function of FIG. 6,

FIG. 6 is an explanatory diagram showing an operation according to a comparative example of a cache operating method proposed by the inventor based on Patent Document 1 in order to make a comparison with the invention described in FIG. 1,

FIG. 7 is a block diagram illustrating an internal structure of a cache memory to be an operating object by a cache operating instruction in FIG. 8,

FIG. 8 is an explanatory diagram showing another example of the cache operating instruction for implementing the cache operation,

FIG. 9 is a block diagram illustrating an internal structure of a TLB in which a page attribute operation of the TLB can be carried out in accordance with an instruction in FIG. 10,

FIG. 10 is an explanatory diagram showing an example of a page attribute operating instruction for implementing the page attribute operation of the TLB, and

FIG. 11 is a block diagram wholly showing an example of a data processor according to the invention.

### DETAILED DESCRIPTION OF THE PREFERRED EMBODIMENTS

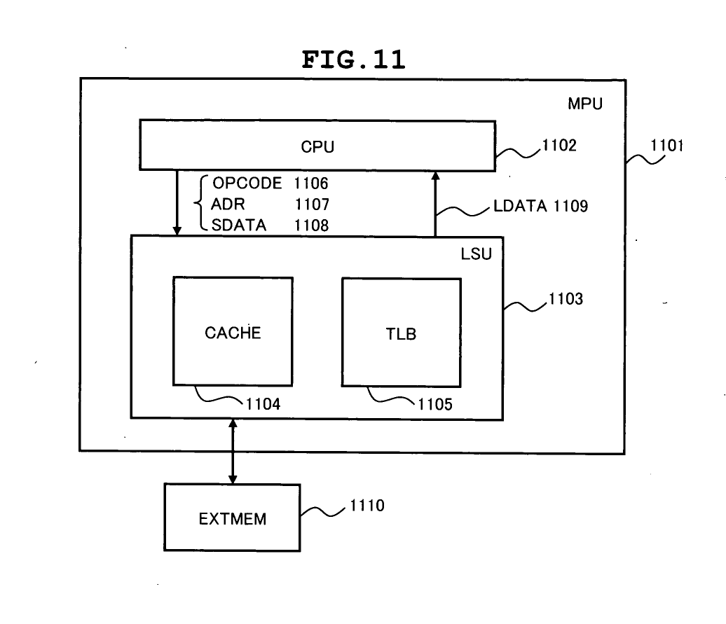

FIG. 11 shows a data processor (MPU) 1101 to which the invention is applied. The data processor 1101 is not particularly restricted but is formed on a semiconductor substrate such as single crystal silicon by a complementary MOS integrated circuit manufacturing technique. The data processor shown in FIG. 11 has a fixed-length basic instruction set having a comparatively small number of bits, for example, 8 bits or 16 bits. A central processing unit (CPU) 1102 and a load store unit (LSU) 1103 are disposed in the processor. An internal portion of the load store unit 1103 is constituted by a cache memory (CACHE) 1104 using a 32 KB and 4-way set associative method and an address translation buffer (TLB) 1105 using a 64-entry full associative method, and inputs an instruction code (OPCODE) 1106, an address (ADR) 1107 and store data (SDATA) 1108 from the CPU 1102 and gives memory access in accordance with contents which are required, and returns load data (LDATA) 1109 to the CPU 1102 in case of a load request. A main memory (EXTMEM) 1110 is connected to an outside of the data processor 1101 and main access is given through the load store unit 1103.

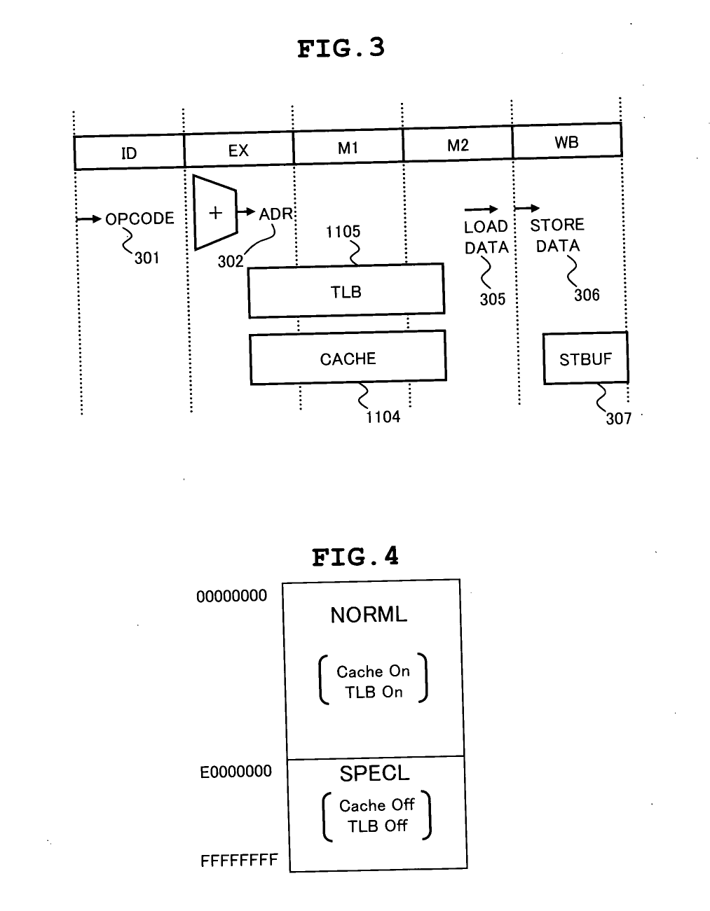

FIG. 3 shows an example of a memory access pipeline after instruction decoding according to the invention in a pipeline of a general data processor. An instruction code (OPCODE) 301 is decoded and reading from a register is carried out in an ID stage, and an addition is performed in an EX stage to generate an address (ADR) 302 and access is given to a memory by using the TLB 1105 and the CACHE 1104 in M1 and M2 stages. In case of load, load data (LDATA) 305 are returned in a latter half of the M2 stage. In case of store, store data (SDATA) 306 are generated in a WB stage and are registered in a store buffer (STBUF) 307.

FIG. 4 shows a virtual memory map of the data processor 1101. There is a 32-bit virtual address space, and addresses of 00000000 to DFFFFFFF are ordinary memory regions and are regions (NORML) in which memory access can be given by using the cache memory 1104 and the TLB 1105. On the other hand, addresses of E0000000 to FFFFFFFF are defined as special regions (SPECL), and an independent resource of an external memory such as a control register or an integrated memory is allocated. Access is given to the special region without using the cache memory 1104 and the TLB 1105.

Next, description will be given to a first example of a cache operating method which can be applied to the data processor 1101. FIG. 2 shows an example of a cache operating instruction for implementing a cache operation. CBP, CBWB and CBI instructions are used for carrying out purge, write-back and invalidate operations of the cache memory respectively, and associative/non-associative operation modes are switched corresponding to an address of [31:24] designated as Rn.

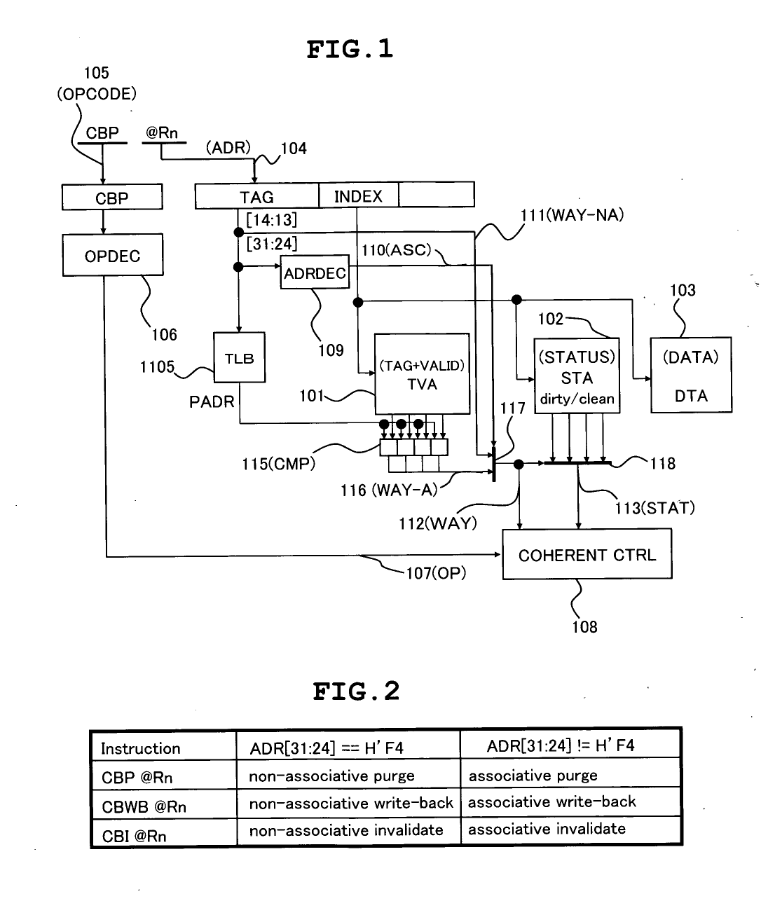

FIG. 1 illustrates an internal structure of the cache memory 1104 to be an operating object in accordance with the cache operating instruction in FIG. 2. The cache memory 1104 is set to be a cache memory using a logical index physical tag method, and has a tag and valid bit array (TVA) 101 for storing a tag (TAG) and a valid bit (VALID) in the cache memory, a status array (STA) 102 for storing information (STATUS) such as dirty and clean, and a data array (DTA) 103 for storing data (DATA). Bits 12 to 5 of a virtual address (ADR) 104 are connected to them in common and are used for an index operation. A cache hit/error decision is carried out in a hit deciding logic (CMP) 115. It is apparent that the data array 103 is provided with a data input/output path for inputting/outputting data related to a cache hit by a cache associative operation and inputting/outputting data for a cache operation such as write-back, which is not particularly shown. For a cache coherency operation, an address decoder (ADRDEC) 109, a selector 117, a selector 118, and a coherency control portion (COHERENT CTRL) 108 are provided.

As an example, description will be given to an operation in the case in which a “CBP@Rn” instruction is executed. First of all, an instruction code (OPCODE) 105 executed in an ID stage is identified by an instruction decoder (OPDEC) 106 and the coherency control portion (COHERENT CTRL) 108 is notified of an operation (OP) 107 indicating that the contents of a processing are the purge. Next, whether bits 31 to 24 of an address designated as Rn determined in the EX stage are H′F4 is decoded by the address decoder (ADRDEC) 109, and it is decided whether an associative mode or a non-associative mode is set and a result of the decision (ASC) 110 is output to the selector 117. In case of the non-associative mode, a status (dirty /clean) corresponding to four ways is read from the status array 102 in order to know a state of a line in which bits 12 to 5 of the address are indicated as indices. The way in the non-associative mode is designated by way designating information (WAY-NA) 111 corresponding to bits 14 to 13 of the address and is selected by the selector 117, and furthermore, a selection is carried out by the selector 118 in response to an output thereof. Consequently, the coherency control portion 108 is notified of a way (WAY) 112 to be an operating object and a status (STAT) 113 to be an object way. The coherency control portion 108 decides the contents of the cache operation from the information of the OP 107, the WAY 112 and the STAT 113, and a status of an object line is updated and data are written back if necessary.

In the case in which bits 31 to 24 of the address are not H′F4, an operation is carried out as an associative purge, and the address is first translated into a physical address by means of a TLB 1105. A tag and a valid bit are read from the tag and valid bit array 101 in accordance with the index designated by the addresses 12 to 5, and a comparison with a physical address PADR is carried out by the hit decision logic (CMP) 115. Furthermore, the status corresponding to four ways is read from the status array (STA) 102 and the coherency control portion 108 is notified of a hit way (WAY-A) 116 and a hit way status. The coherency control portion 108 carries out an operation of an object line based on the OP 107, the WAY 112 and the STAT 113 which are obtained in the same manner as in the non-associative mode.

The CBWB and CBI instructions are executed in the same procedure and the execution is different in that the contents of the operation of the coherency control portion 108 are the write-back and the invalidate based on a result of decode of an instruction in the OPDEC (106).

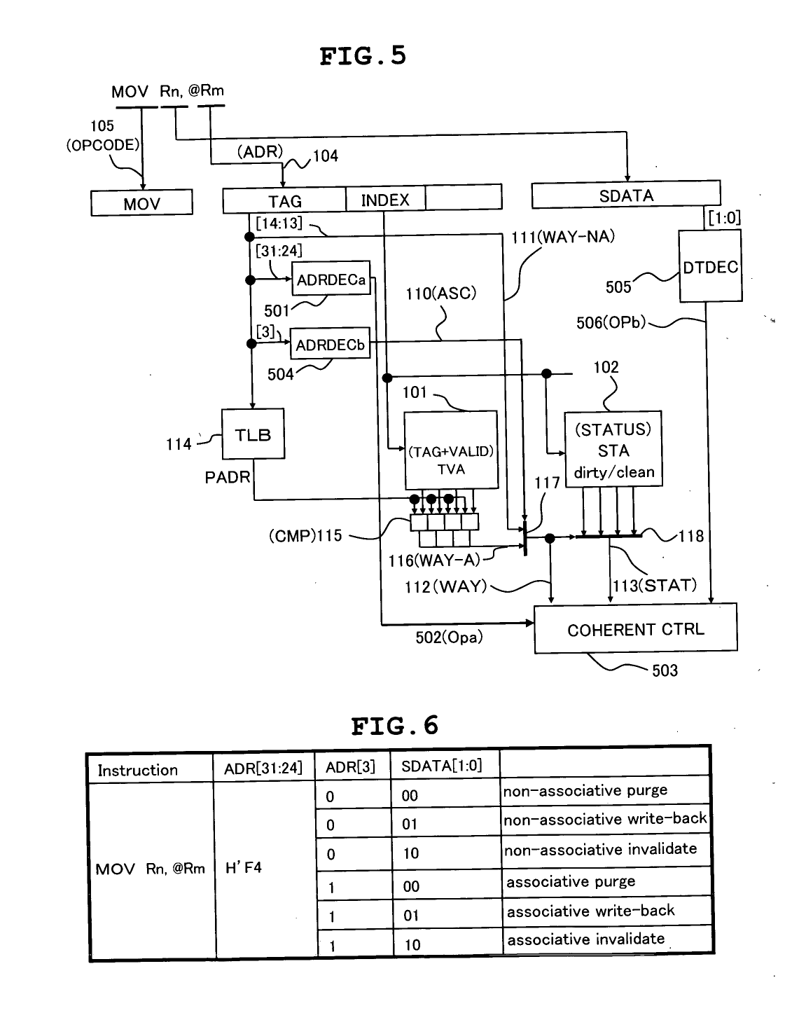

FIG. 6 shows, as a comparative example, a cache operating method proposed by the inventor based on the Patent Document 1 in order to make a comparison with the invention described with reference to FIG. 1. A cache coherency control is carried out via software by writing data to a specific address using “MOV Rn, @Rm” to be a data transfer instruction without using a dedicated instruction. In the case in which bits 31 to 24 of an address Rm to be designated are H′F4, they are treated as the cache operation in place of the normal data transfer. “Associative” or “non-associative” is designated based on 0/1 of a bit 3 of the address, and furthermore, the contents of the operation are selected as purge, write-back and invalidate depending on bits 1 and 0 of data. FIG. 5 shows an inner portion of a cache memory according to the comparative example proposed by the inventor in order to implement the function of FIG. 6. Although an MOV instruction is decoded in the ID stage, whether it is indicative of the cache control is not determined in this stage. Next, whether the bits 31 to 24 of the address are H′F4 in the EX stage is decoded by an address decoder (ADRDECa) 501 and whether they are indicative of a normal data transfer or a coherency control is decided, and a coherency control portion (COHERENT CTRL) 503 is notified of a control signal (OPa) 502. Furthermore, the bit 3 of the address is decided by an address decoder (ADRDECb) 504 to identify “associative” or “non-associative”, and a result of the identification (ASC) 110 is output to the selector 117. In case of the non-associative mode, the status (STAT) 113 corresponding to four ways is read from the status array (STA) 102 in order to know the state of a line in which the bits 12 to 5 of the address are indicated as indices. An operating object way is designated by the way designating information (WAY-NA) 111 corresponding to bits 14 to 13 of the address and the coherency control portion 503 is notified of the way of the operating object and the status of the object way. Furthermore, a value of store data Rn obtained in a WB stage is identified by a data decoder (DTDEC) 505 and the coherency control portion 503 is notified of an identification signal (OPb) 506 of purge, write-back and invalidate in the cache operation. The coherency control portion 503 decides the contents of the cache operation from information of the OPa 502, the OPb 506, the WAY 112 and the STAT 113, and the status of the object line is updated and data are written back if necessary. The associative mode is different in that a hit decision is carried out based on the information of the tag and valid bit array 101 to determine a way to be an operating object. As is apparent from the foregoing, in the cache operation according to an example of the invention in relation to FIGS. 1 and 2, six types of cache operations are implemented while the cache operation is assigned to three types of instruction codes to reduce a consumption of an instruction space. Furthermore, it is possible to decide whether the contents indicate the cache operation or not in accordance with an instruction code determined in an early stage even if the address is not identified as in FIGS. 5 and 6. Therefore, it is possible to determine, in the early stage, whether a control logic for a normal cache operation or the coherency control portion 503 for the cache operation is to be activated, and a power reducing operation can be implemented. Furthermore, the processing is carried out by using an incidental address to an instruction code without using store data which is defined when the write-back (WB) stage of the pipeline is started as shown in FIGS. 5 and 6. Consequently, it is possible to carry out the start of the cache operation earlier in an execution (EX) stage in place of the conventional WB stage. Thus, it is possible to contribute to an enhancement in the processing performance of the cache operation.

FIG. 8 shows another example of the cache operating instruction for implementing the cache operation. FIG. 8 is different from FIG. 2 in that only a “CB @Rn” instruction is assigned to the cache operation and purge/write-back/invalidate are also changed over in addition to associative/non-associative with an address designated at that time.

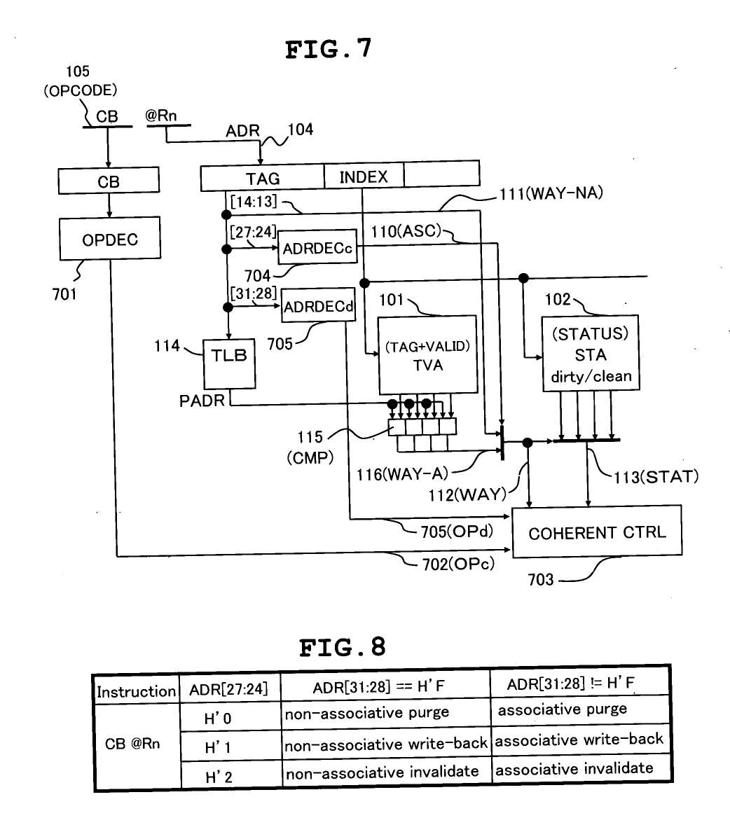

FIG. 7 illustrates an internal structure of the cache memory 1104 to be an operating object in accordance with a cache operating instruction in FIG. 8. First of all, the instruction code (OPCODE) 105 executed in the ID stage is identified by an instruction decoder (OPDEC) 701 and a coherency control portion (COHERENT CTRL) 703 is notified of a coherency control signal (OPc) 702. Next, whether bits 31 to 28 of an address designated with Rn determined in the EX stage are H′F is decoded by an address decoder (ADRDECc) 704, and whether the associative mode or the non-associative mode is set is decided and the decision result signal (ASC) 110 is output. In case of the non-associative mode, a status corresponding to four ways is read from the status array 102 in order to know the state of the line in which bits 12 to 5 of the address are indicated as indices. The operating object way is designated by the bits 14 to 13 of the address. Therefore, the coherency control portion 703 is notified of the way designating information (WAY) 112 to be the operating object and the status (STAT) 113 of the object way. At the same time, bits 27 to 24 of the address are decoded by an address decoder (ADRDECd) 705 and the coherency control portion 703 is notified of an identification signal (OPd) 706 of purge, write-back and invalidate in the cache operation. The coherency control portion 703 decides the contents of the cache operation from information of the OPc 702, the OPd 705, the WAY 112 and the STAT 113, and the cache operation of the object cache line is carried out. In the case in which the bits 31 to 24 of the address are not H′F, an operation is carried out in the associative mode, and a specific way determining method is set to be identical to that in FIG. 1 and others are set to be the same operation as that in the non-associative mode.

Although a second example shown in FIGS. 7 and 8 is more excellent than the first example in FIGS. 1 and 2 in that only one instruction code is used, the contents of the cache operation which are designated (purge/write-back/invalidate) cannot be determined until the EX stage for determining the address is set. However, the coherency control operation can be started after information is read from the TVA 101 and the STA 102. Therefore, a problem of a deterioration in a performance is not generated in many embodiments.

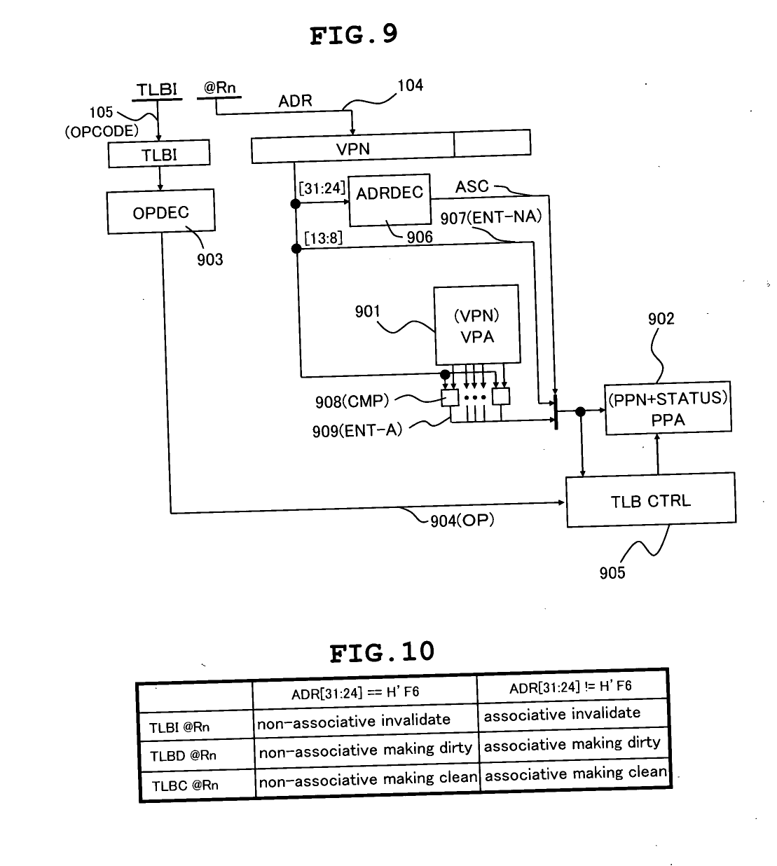

Next, description will be given to an example of a page attribute operating method of a TLB which can be applied to the data processor 1101. FIG. 9 illustrates an internal structure of the TLB. The TLB 1105 has a virtual page number (VPN) array (VPA) 901 corresponding to 64 entries and a physical page number (PPN) and status (STATUS) array (PPA) 902, and furthermore, includes an address decoder (ADRDEC) 906, an address comparator (CMP) 908, a selector 910 and a TLB control portion (TLB CTRL) 905. In a normal operation, a virtual page number (VPN) of the address ADR 1107 is input from the CPU 1102 and a coincident comparison and decision with all entries is carried out by the address comparator (CMP) 908, and a physical page number (PPN) and an attribute of a hit entry are output to carry out a translation from a virtual address to a physical address. For the attribute of a page, there are a V bit indicating whether the entry is valid or not and a D bit indicating whether write to the same page is carried out or not. The D bit is utilized for an operation of a virtual memory system in an OS (Operating System) and is a dirty bit indicating whether or not the contents of the page are to be written back into a real storage device in page-in and page-out operations (it is referred to as a dirty state). When the write to the corresponding page is carried out in a state in which the D bit is zero, an exception is generated and a processing of writing one to the D bit by software (making dirty) is executed. In the case in which the write-back is carried out in the page-out, furthermore, a processing of writing zero to the D bit by software (making clean) is executed in the same manner. In the case in which a page table of the OS is changed, moreover, a processing of invalidating a TLB entry (writing zero to the V bit, invalidate) is executed. A method of designating these processing includes “associative” and “non-associative” in the same manner as in the cache, and an operation of a hit entry for a given VPN is carried out in the associative mode and an entry to be operated is directly designated in the non-associative mode.

FIG. 10 shows an example of an attribute managing and operating instruction for implementing the attribute managing operation of the TLB. Invalidate, making clean and making dirty can be carried out in three instructions of “TLBI @Rn”, “TLBC @Rn” and “TLBD @Rn” for the attribute managing operation. It is possible to select the “associative” or “non-associative” of an operation mode according to whether an address designated to be Rn is H′F6 or not. In the page operation of the TLB 1105, an operation for an address translation pair of a virtual page number and a physical page number and a management of data accompanied therewith are carried out by the OS. Therefore, a support is performed for only the page attribute operation in accordance with an instruction. Referring to the TLB 1105, accordingly, it is not necessary to support an operation such as purge in accordance with an instruction.

With reference to FIG. 9, description will be given to a processing operation to be carried out in accordance with a TLBI instruction which is one of the page attribute operating instructions for carrying out the page attribute operation of the TLB. First of all, the instruction code (OPCODE) 105 executed in the ID stage is identified by an instruction decoder (OPDEC) 903 and the TLB control portion (TLB CTRL) 905 is notified of an operation by a TLB invalidate signal (OP) 904. Next, whether bits 31 to 24 of the address designated with Rn determined in the EX stage are H′F6 is decoded by the address decoder (ADRDEC) 906 to decide the associative mode or the non-associative mode. In case of the non-associative mode, the bits 13 to 8 of the address are treated as entry designating information (ENT-NA) 907 and the corresponding V bit of the physical page number and status array (PPA) 902 is written to be zero in accordance with an instruction from the TLB control portion 905. In the case in which the bits 31 to 24 of the address are not H′F6, an operation is carried out in the associative mode and it is decided whether a VPN designated with Rn and a VPN corresponding to 64 entries in the virtual page number array (VPA) 901 are coincident or not by the address comparator (CMP) 908, and the TLB control portion 905 is notified of an entry number (ENT-A) 909 obtained therein, and a V bit of the same entry is rewritten into zero. In case of the TLBC instruction and the TLBD instruction, differently, the rewritten contents are changed into D=0 and D=1.

Referring to the page attribute operation of the TLB, similarly, it is possible to carry out many TLB operations by addressing while assigning a plurality of TLB operations to a small number of instruction codes to reduce a consumption of an instruction space. As compared with the case in which the TLB operation is carried out by using a data transfer instruction, accordingly, it is possible to implement a lower power operation. Moreover, the store data are not used. By starting the TLB operation in an early stage of a pipeline, therefore, it is possible to contribute to an enhancement in a processing performance.

According to various embodiments described above, it is possible to obtain the following functions and advantages.

[1] It is possible to reduce the number of instruction codes required for the operations of the cache memory 1104 and the TLB 1105 and to effectively utilize an instruction code space, and to enhance an instruction code efficiency in a data processor in which the number of bits of a basic instruction is an instruction set of a fixed-length instruction having a small number of bits, for example, 8 bits or 16 bits.

[2] As compared with a method of designating the operations of the cache memory 1104 and the TLB 1105 in a combination of a transfer instruction, a special address and data, whether the contents of a processing are a normal data transfer or a cache and TLB operation can be determined in an earlier stage. Consequently, it is possible to stop an unnecessary logical operation, thereby contributing to a reduction in a power.

[3] As compared with a conventional technique for determining the contents of the operations of the cache memory 1104 and the TLB 1105 by using stored at a designated to a transfer instruction, it is possible to start the operation processings of the cache memory and the TLB in an earlier stage. Consequently, it is possible to expect an enhancement in a processing performance.

While the invention made by the inventor has been specifically described above based on the embodiment, it is apparent that the invention is not restricted thereto but various changes can be made without departing from the scope of the invention.

For example, the cache memory is not restricted to a set associative configuration but may be a direct map or full associative configuration. The data processor may have such a structure as to include only one of the cache memory and the TLB. The object of the invention is not restricted to the cache memory and the TLB but may be another logical block which is activated by using a predetermined instruction code. The invention can be widely applied to a condition that the function of the activated logical block is selected by using an instruction code, a part of addresses which are incidental to the instruction code or a part of addresses which are incidental to the instruction code.

What is claimed is:

1. A data processing device comprising:
a central processing unit; and
a plurality of logical blocks to be connected to the central processing unit,
wherein the central processing unit sets a predetermined logical block to be a control object based on a result of decode of a predetermined instruction code, and
wherein a function of the predetermined logical block is selected based on the result of decode of the predetermined instruction code and a part of address information which is incidental to the predetermined instruction code.

2. The data processing device according to claim 1, wherein the predetermined logical block is a cache memory and the function to be selected is an associative mode using an associative retrieval for a cache coherency control or a non-associative mode which does not use the associative retrieval.

3. The data processing device according to claim 2, wherein the function to be selected is contents of the cache coherency control.

4. The data processing device according to claim 3, wherein the contents of the cache coherency control are purge, write-back and invalidate.

5. The data processing device according to claim 1, wherein the predetermined logical block is a TLB and the function to be selected is an associative mode using an associative retrieval in a page attribute operation control of the TLB or a non-associative mode which does not use the associative retrieval.

6. The data processing device according to claim 5, wherein the function to be selected is contents of the page attribute operation control.

7. The data processing device according to claim 6, wherein the contents of the page attribute operation control are making dirty, making clean and invalidate.

8. A data processing device having a central processing unit and a plurality of logical blocks to be connected to the central processing unit,
wherein the central processing unit sets a predetermined logical block as a control object based on a result of decode of a predetermined instruction code, and
wherein a function of the predetermined logical block is selected based on a part of address information which is incidental to the predetermined instruction code.

9. The data processing device according to claim 8, wherein the predetermined logical block is a cache memory and the function to be selected is an associative mode using an associative retrieval for a cache coherency control or a non-associative mode which does not use the associative retrieval, and contents of the cache coherency control.

10. The data processing device according to claim 9, wherein the contents of the cache coherency control are purge, write-back and invalidate.

11. The data processing device according to claim 8, wherein the predetermined logical block is a TLB and the function to be selected is an associative mode using an associative retrieval in a page attribute operation control of the TLB or a non-associative mode which does not use the associative retrieval, and contents of the page attribute operation control.

12. The data processing device according to claim 11, wherein the contents of the page attribute operation control are making dirty, making clean and invalidate.

13. A data processing device having a logical block to be activated by using a predetermined instruction code, wherein a function of the logical block is selected by using the instruction code and a part of addresses which are incidental to the instruction code.

14. A data processing device having a logical block to be activated by using a predetermined instruction code, wherein a function of the logical block which is activated is selected by using a part of addresses which are incidental to the instruction code.
